(19) United States
(12) Patent Application Publication
(10) Pub. No.: US 2026/0074178 A1
(43) Pub. Date: Mar. 12, 2026

(54) COMPOSITE SUBSTRATE FOR RECHARGEABLE LITHIUM BATTERY AND METHOD OF FABRICATING THE SAME

(71) Applicant: SAMSUNG SDI CO., LTD., Yongin-si (KR)

(72) Inventors: Junyoung KIM, Yongin-si (KR); Suhyun KIM, Yongin-si (KR); Wonhyung LEE, Yongin-si (KR); Jungwook CHA, Yongin-si (KR); KyuSeo LEE, Yongin-si (KR); Yeonhee YOON, Yongin-si (KR); Dayoung KANG, Yongin-si (KR); Minseok KWON, Yongin-si (KR); Seokho WOO, Yongin-si (KR)

(73) Assignee: SAMSUNG SDI CO., LTD., Yongin-si (KR)

(21) Appl. No.: 19/270,820

(22) Filed: Jul. 16, 2025

(30) Foreign Application Priority Data
Sep. 6, 2024 (KR) 10-2024-0121243

(51) Int. Cl. H01M 4/04; H01M 4/13; H01M 4/139; H01M 4/66

(52) U.S. Cl. CPC H01M 4/0426; H01M 4/0404; H01M 4/13; H01M 4/139; H01M 4/661; H01M 4/667; H01M 4/668

(57) ABSTRACT

Disclosed are negative electrode composite substrates and fabrication methods thereof. The method of fabricating a negative electrode composite substrate includes performing a plasma treatment on at least a portion of a surface of a support layer, forming a first metal layer on the surface of the support layer, and forming a second metal layer on the first metal layer. Forming the first metal layer includes impregnating the support layer with a first solution including a first copper ion to adsorb the first copper ion to the surface of the support layer, and impregnating the support layer with a second solution including a reductant to reduce the first copper ion. Forming the second metal layer includes impregnating the support layer and the first metal layer on the support layer with a third solution including a second copper ion.

### CROSS-REFERENCE TO RELATED APPLICATION

This application claims priority under 35 U.S.C § 119 to Korean Patent Application No. 10-2024-0121243 filed on Sep. 6, 2024 in the Korean Intellectual Property Office, the disclosure of which is hereby incorporated by reference in its entirety.

### BACKGROUND

The present disclosure relates to a composite substrate for a rechargeable lithium battery, and a method of fabricating the composite substrate.

With increasing presence of battery-using electronic devices, such as, e.g., mobile phones, laptop computers, and electric vehicles, there is increasing demand for rechargeable batteries with high energy density and high capacity. Therefore, improving performance of rechargeable lithium batteries may be advantageous.

A rechargeable lithium battery includes a positive electrode, a negative electrode, and an electrolyte, the positive and negative electrodes include an active material in which intercalation and deintercalation are possible, and the rechargeable lithium battery generates electrical energy caused by oxidation and reduction reactions when lithium ions are intercalated and deintercalated.

### SUMMARY

An example embodiment of the present disclosure includes a composite substrate with improved stability, where a support layer is substantially uniformly plated with a copper-containing metal layer.

An example embodiment of the present disclosure includes a rechargeable lithium battery including the composite substrate.

According to an example embodiment of the present disclosure, a method of fabricating a negative electrode composite substrate for a rechargeable lithium battery may include performing a plasma treatment on at least a portion of a surface of a support layer, forming a first metal layer on the surface of the support layer, and forming a second metal layer on the first metal layer. Forming the first metal layer may include impregnating the support layer with a first solution including a first copper ion to adsorb the first copper ion to the surface of the support layer; and impregnating the support layer with a second solution including a reductant to reduce the first copper ion. Forming the second metal layer may include impregnating the support layer and the first metal layer on the support layer with a third solution including a second copper ion.

According to an example embodiment of the present disclosure, a negative electrode composite substrate for a rechargeable lithium battery may include a support layer that includes a polymer film, a metal layer on the support layer and include at least one of copper and copper oxide, and a negative electrode coating layer on the metal layer. A thickness of the support layer may be in a range of about 2 μm to about 10 μm. An adhesive force between the metal layer and the support layer may be in a range of about 700 N/m to about 1,200 N/m.

### BRIEF DESCRIPTION OF DRAWINGS

FIG. 1 illustrates a simplified conceptual diagram showing a rechargeable lithium battery, according to some example embodiments of the present disclosure.

FIGS. 2 to 5 illustrate simplified diagrams showing a rechargeable lithium battery, according to some example embodiments of the present disclosure.

FIG. 6 illustrates a cross-sectional view showing a negative electrode composite substrate for a rechargeable lithium battery, according to some example embodiments of the present disclosure.

FIG. 7 illustrates an enlarged view showing section M of FIG. 6.

FIG. 8 illustrates a flow chart showing a method of fabricating a negative electrode composite substrate for a rechargeable lithium battery, according to some example embodiments of the present disclosure.

FIG. 9 illustrates a cross-sectional view showing a plasma treatment of a surface of a support layer according to some example embodiments of the present disclosure.

FIG. 10 illustrates an enlarged view showing section N of FIG. 9.

FIG. 11 illustrates a conceptual diagram showing a method of forming a first metal layer and a second metal layer, according to some example embodiments of the present disclosure.

FIG. 12 illustrates an enlarged view showing section O of FIG. 11.

FIG. 13 illustrates an enlarged view showing section P of FIG. 11.

FIG. 14 illustrates an enlarged view showing section Q of FIG. 11.

FIG. 15 illustrates an enlarged view showing section R of FIG. 11.

### DETAILED DESCRIPTION OF EMBODIMENTS

In order to sufficiently understand the configuration and effect of the present disclosure, some example embodiments of the present disclosure are described with reference to the accompanying drawings. It should be noted, however, that the present disclosure is not limited to the following example embodiments, and may be implemented in various forms. Rather, the example embodiments are provided only to disclose the present disclosure and let those skilled in the art fully know the scope of the present disclosure.

In this description, it is understood that, when an element is referred to as being “on” another element, the element can be “directly on” the other element, or intervening elements may be present therebetween. In the drawings, thicknesses of some components may be exaggerated for effectively explaining the technical contents. Like reference numerals refer to like elements throughout the specification.

Unless otherwise noted in this description, the expression of singular form may include the expression of plural form. In addition, unless otherwise specially noted, the phrase “A or B” may indicate “A but not B,” “B but not A,” and “A and B.” The terms “comprises/includes” and/or “comprising/including” used in this description do not exclude the presence or addition of one or more other components.

In this description, the term “combination thereof” may refer to a mixture, a stack, a composite, a copolymer, an alloy, a blend, or a reaction product.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by a method widely known to those skilled in the art, for example, by a particle size analyzer, a transmission electron microscope (TEM) image, or a scanning electron microscope (SEM) image. Alternatively, a dynamic light-scattering measurement device is used to perform a data analysis, the number of particles is counted for each particle size range, and then from this, an average particle diameter (D₅₀) value may be obtained through a calculation. Dissimilarly, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac, Inc), irradiated with ultrasonic waves of 28 kHz at a power of 60 W, and then an average particle diameter (D₅₀) is calculated in the 50% standard of particle diameter distribution in the measurement device.

When the terms “about” or “substantially” are included in this specification in connection with a numerical value, it is intended that the associated numerical value include a tolerance of ±10% around the stated numerical value. When ranges are specified, the range includes all values therebetween such as increments of 0.1%.

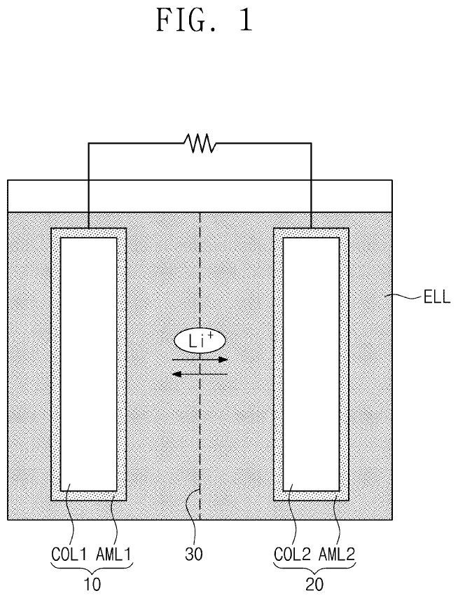

FIG. 1 illustrates a simplified conceptual diagram showing a rechargeable lithium battery, according to an example embodiment of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced apart from each other across the separator 30. The separator 30 may be disposed between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated in the electrolyte ELL.

The electrolyte ELL may be or include a medium by which lithium ions are transferred between the positive electrode 10 and the negative electrode 20. In the electrolyte ELL, the lithium ions may move through the separator 30 toward one of the positive electrode 10 and the negative electrode 20.

### Positive Electrode 10

The positive electrode 10 for a rechargeable lithium battery may include a current collector COL1 and a positive electrode active material layer AML1 formed on the current collector COLL. The positive electrode active material layer AML1 may include a positive electrode active material, and may further include a binder and/or a conductive material.

For example, the positive electrode 10 may further include an additive that can be configured as a sacrificial positive electrode.

An amount of the positive electrode active material may be in a range of about 90 wt % to about 99.5 wt % relative to 100 wt % of the positive electrode active material layer AML1. An amount of each of the binder and the conductive material may be in a range of about 0.5 wt % to about 5 wt % relative to 100 wt % of the positive electrode active material layer AML1.

The binder may be configured to improve attachment of positive electrode active material particles to each other, and to improve attachment of the positive electrode active material to the current collector COLL. The binder may include, for example, at least one of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, or nylon, but the present disclosure is not limited thereto.

The conductive material may be included to provide an electrode with conductivity, and any suitable conductive material that does not cause a chemical change in a battery may be included as the conductive material. The conductive material may include, for example, a carbon-based material such as at least one of natural graphite, artificial graphite, carbon black, acetylene black, Ketjen black, carbon fiber, carbon nano-fiber, and carbon nano-tube; a metal powder or metal fiber containing one or more of copper, nickel, aluminum, and silver; a conductive polymer such as a polyphenylene derivative; or a mixture thereof.

Aluminum (Al) may be included as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium. For example, the positive electrode active material may include at least one kind of composite oxide including lithium and metal that is or includes at least one of cobalt, manganese, nickel, and a combination thereof.

The composite oxide may include a lithium transition metal composite oxide, for example, at least one of lithium-nickel-based oxide, lithium-cobalt-based oxide, lithium-manganese-based oxide, lithium-iron-phosphate-based compounds, cobalt-free nickel-manganese-based oxide, or a combination thereof.

For example, the positive electrode active material may include a compound expressed by one of chemical formulae below. LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A may be or include at least one of Ni, Co, Mn, or a combination thereof, X may be or include at least one of Al, Ni, Co, Mn, Cr, Fe, Mg, Sr, V, a rare-earth element, or a combination thereof, D may be or include at least one of O, F, S, P, or a combination thereof, G may be or include at least one of Al, Cr, Mn, Fe, Mg, La, Ce, Sr, V, or a combination thereof, and L¹ may be or include at least one of Mn, Al, or a combination thereof.

For example, the positive electrode active material may be or include a high-nickel-based positive electrode active material having a nickel amount that is equal to or greater than about 80 mol %, equal to or greater than about 85 mol %, equal to or greater than about 90 mol %, equal to or greater than about 91 mol %, or equal to or greater than about 94 mol % and equal to or less than about 99 mol % relative to 100 mol % of metal devoid of lithium in the lithium transition metal composite oxide. The high-nickel-based positive electrode active material may achieve high capacity, and thus may be applicable to a high-capacity and high-density rechargeable lithium battery.

### Negative Electrode 20

The negative electrode 20 for a rechargeable lithium battery may include a current collector COL2, and a negative electrode active material layer AML2 positioned on the current collector COL2. The negative electrode active material layer AML2 may include a negative electrode active material, and may further include a binder and/or a conductive material.

For example, the negative electrode active material layer AML2 may include a negative electrode active material in a range of about 90 wt % to about 99 wt %, a binder in a range of about 0.5 wt % to about 5 wt %, and a conductive material in a range of about 0 wt % to about 5 wt %.

The binder may be configured to improve attachment of negative electrode active material particles to each other, and to improve attachment of the negative electrode active material to the current collector COL2. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, or a combination thereof.

The aqueous binder may include at least one of styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, or a combination thereof.

When an aqueous binder is included as the negative electrode binder, a cellulose-based compound capable of providing viscosity may further be included. The cellulose-based compound may include one or more of carboxymethyl cellulose, hydroxypropylmethyl cellulose, methyl cellulose, and alkali metal salts thereof. The alkali metal may include at least one of Na, K, or Li.

The dry binder may include a fibrillizable polymer material, for example, at least one of polytetrafluoroethylene, polyvinylidene fluoride, polyvinylidene fluoride-hexafluoropropylene copolymer, polyethylene oxide, or a combination thereof.

The conductive material may be included to provide an electrode with conductivity, and any suitable conductive material that does not cause a chemical change in a battery may be included as the conductive material. For example, the conductive material may include a carbon-based material such as at least one of natural graphite, artificial graphite, carbon black, acetylene black, Ketjen black, carbon fiber, carbon nano-fiber, and carbon nano-tube; a metal powder or metal fiber including one or more of copper, nickel, aluminum, and silver; a conductive polymer such as a polyphenylene derivative; or a mixture thereof.

The current collector COL2 may include at least one of a copper foil, a nickel foil, a stainless-steel foil, a titanium foil, a nickel foam, a copper foam, a polymer substrate coated with a conductive metal, or a combination thereof.

### Negative Electrode Active Material

The negative electrode active material in the negative electrode active material layer AML2 may include at least one of a material that can reversibly intercalate and deintercalate lithium ions, lithium metal, a lithium metal alloy, a material that can dope and de-dope lithium, or transition metal oxide.

The material that can reversibly intercalate and deintercalate lithium ions may include a carbon-based negative electrode active material, for example, crystalline carbon, amorphous carbon, or a combination thereof. For example, the crystalline carbon may include graphite such as non-shaped, sheet-shaped, flake-shaped, sphere-shaped, or fiber-shaped natural or artificial graphite, and the amorphous carbon may include at least one of soft carbon, hard carbon, mesophase pitch carbon, or calcined coke.

The lithium metal alloy may include an alloy of lithium and metal such as or including at least one of Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material or a Sn-based negative electrode active material. The Si-based negative electrode active material may include at least one of silicon, silicon-carbon composite, SiOₓ (where 0<x<2), Si-Q alloy (where Q is or includes at least one of alkali metal, alkaline earth metal, Group 13 element, Group 14 element (except for Si), Group 15 element, Group 16 element, transition metal, a rare-earth element, or a combination thereof), or a combination thereof. The Sn-based negative electrode active material may include at least one of Sn, SnO₂, a Sn-based alloy, a combination thereof.

The silicon-carbon composite may be or include a composite of silicon and amorphous carbon. According to an example embodiment, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles, and may also include an amorphous carbon coating layer positioned on a surface of the core.

The Si-based negative electrode active material or the Sn-based negative electrode active material may be included in combination with a carbon-based negative electrode active material.

### Separator 30

Based on a type of the rechargeable lithium battery, the separator 30 may be present between the positive electrode 10 and the negative electrode 20. The separator 30 may include one or more of polyethylene, polypropylene, and polyvinylidene fluoride, and may have a multi-layered separator thereof such as a polyethylene/polypropylene bi-layered separator, a polyethylene/polypropylene/polyethylene tri-layered separator, and a polypropylene/polyethylene/polypropylene tri-layered separator.

The separator 30 may include a porous substrate and a coating layer positioned on one surface, or on opposite surfaces, of the porous substrate, and the coating layer includes at least one of an organic material, an inorganic material, or a combination thereof.

The porous substrate may be or include a polymer layer including at least one of polyolefin such as polyethylene and polypropylene, polyester such as polyethylene terephthalate and polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulphide, polyethylene naphthalate, glass fiber, Teflon, and polytetrafluoroethylene, or may be or include a copolymer or mixture including two or more of the materials mentioned above.

The organic material may include a polyvinylidenefluoride-based copolymer or a (meth)acrylic copolymer.

The inorganic material may include an inorganic particle such as or including at least one of Al₂O₃, SiO₂, TiO₂, SnO₂, CeO₂, MgO, NiO, CaO, GaO, ZnO, ZrO2, Y₂O₃, SrTiO3, BaTiO3, Mg(OH)₂, Boehmite, or a combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may be configured as a medium for transmitting ions that participate in an electrochemical reaction of the battery.

The non-aqueous organic solvent may include at least one of a carbonate-based solvent, an ester-based solvent, an ether-based solvent, a ketone-based solvent, an alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), or butylene carbonate (BG).

The ester-based solvent may include at least one of methyl acetate, ethyl acetate, n-propyl acetate, dimethyl acetate, methyl propionate, ethyl propionate, decanolide, mevalonolactone, valerolactone, or caprolactone.

The ether-based solvent may include at least one of dibutyl ether, tetraglyme, diglyme, dimethoxyethane, 2-methyltetrahydrofuran, 2.5-dimethyltetrahydrofuran, or tetrahydrofuran. The ketone-based solvent may include cyclohexanone. The alcohol-based solvent may include at least one of ethyl alcohol or isopropyl alcohol, and the aprotic solvent may include at least one of nitriles such as R—CN (where R is a hydrocarbon group having a C2 to C20 linear, branched, or cyclic structure and may include a double bond, an aromatic ring, or an ether group); amides such as dimethylformamide; dioxolanes such as 1,3-dioxolane or 1.4-dioxolane; or sulfolanes.

The non-aqueous organic solvent may be included alone or in a mixture of two or more substances.

In addition, when a carbonate-based solvent is included, a cyclic carbonate and a chain carbonate may be mixed, and the cyclic carbonate and the chain carbonate may be mixed in a volume ratio in a range of about 1:1 to about 1:9.

The lithium salt may dissolve in the non-aqueous organic solvent to constitute a supply source of lithium ions in a battery, and plays a role in enabling a basic operation of a rechargeable lithium battery and in promoting the movement of lithium ions between positive and negative electrodes. The lithium salt may include, for example, at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers in a range of 1 to 20), lithium trifluoromethane sulfonate, lithium tetrafluoroethanesulfonate, lithium difluorobis(oxalato)phosphate (LiDFOP), and lithium bis(oxalato)borate (LiBOB)

### Rechargeable Lithium Battery

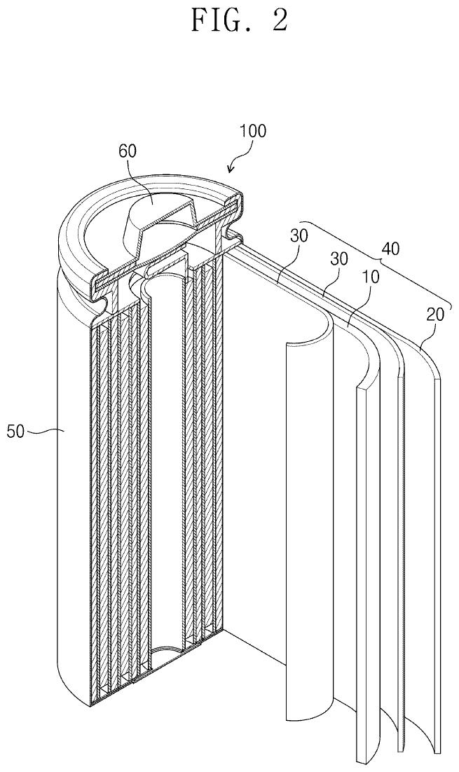

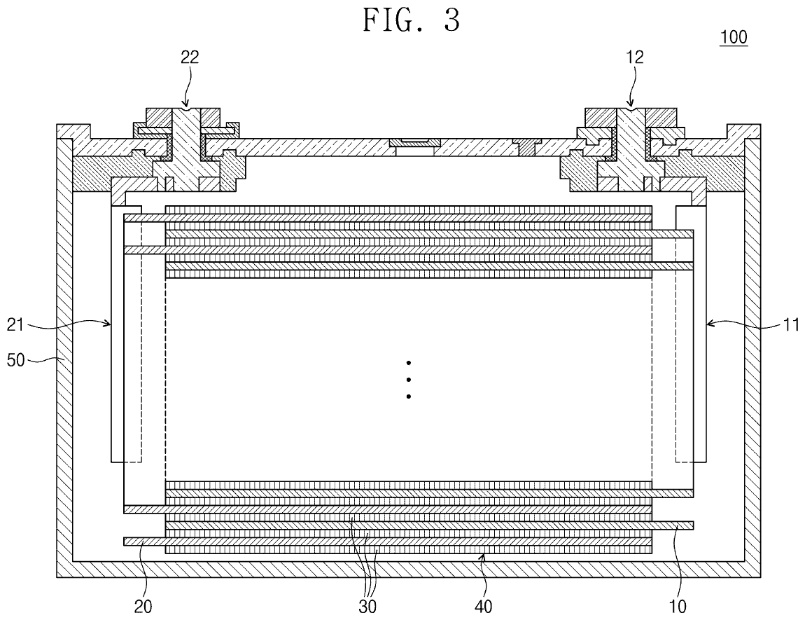

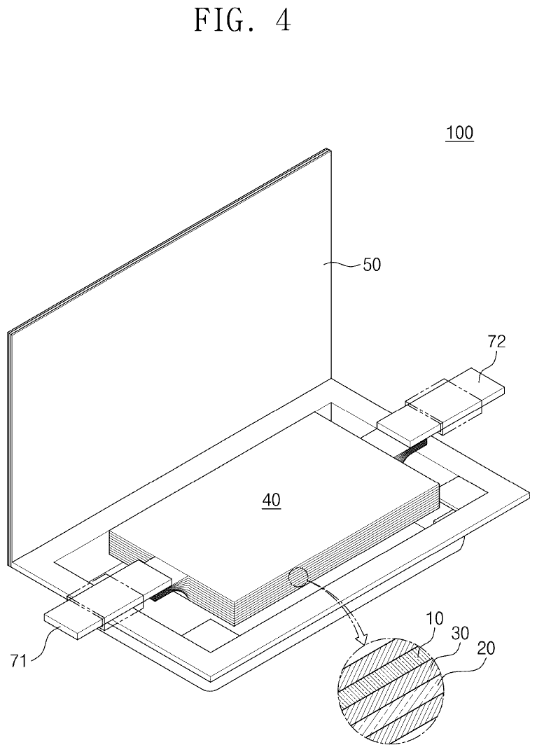

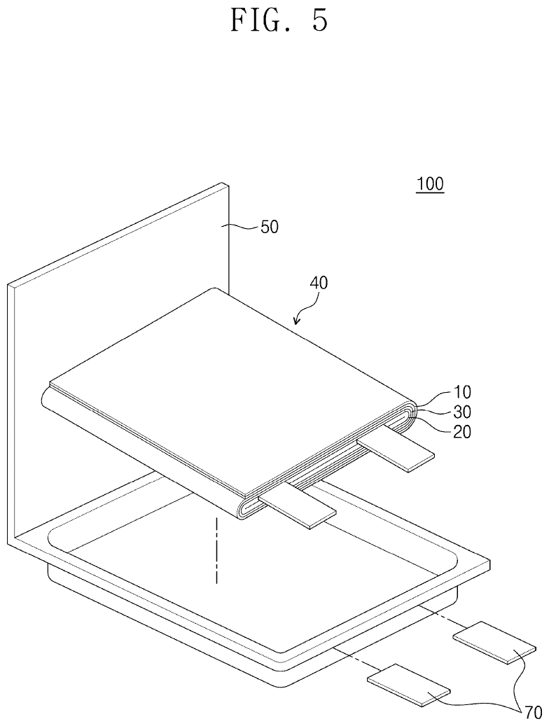

Based on a shape of a rechargeable lithium battery, the rechargeable lithium battery may be classified into cylindrical, prismatic, pouch, and coin types. FIGS. 2 to 5 are simplified diagrams illustrating a rechargeable lithium battery according to an example embodiment, with FIG. 2 illustrating a cylindrical battery, FIG. 3 illustrating a prismatic battery, and FIGS. 4 and 5 illustrating pouch-type batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated in an electrolyte (not shown). The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70 illustrated in FIG. 5, or a positive electrode tab 71 and a negative electrode tab 72 illustrated in FIG. 4, the electrode tabs 70/71/72 forming an electrical path for externally inducing a current generated in the electrode assembly 40.

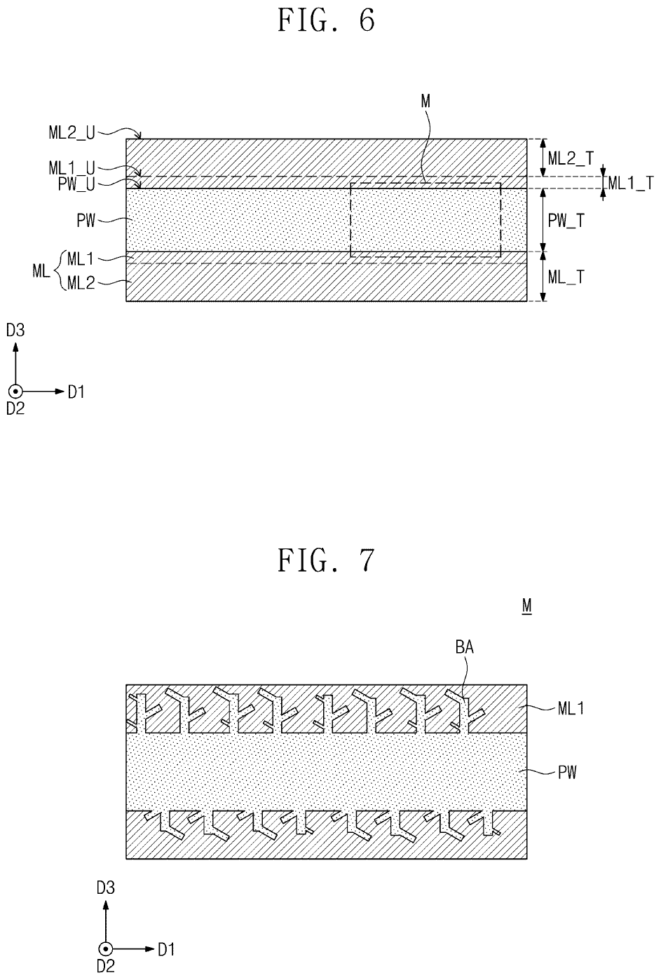

FIG. 6 is a cross-sectional view illustrating a negative electrode composite substrate for a rechargeable lithium battery, according to some example embodiments of the present disclosure. FIG. 7 is an enlarged view illustrating section “M” of FIG. 6. For brevity of description, omission is made to avoid a repetitive explanation of the rechargeable lithium battery discussed above with reference to FIGS. 1 to 5.

Referring to FIG. 6, a negative electrode composite substrate for a rechargeable lithium battery may include a support layer PW and a metal layer ML on a surface PW_U of the support layer PW. The support layer PW may include a polymer film, such as or including at least one of a polyethylene film, a polypropylene film, a polyvinylidene chloride film, and a multi-layered film composed of any combination thereof. A thickness PW_T of the support layer PW may range, for example, from about 2 μm to about 10 μm.

The surface PW_U of the support layer PW may include a plurality of couplers BA. Each of, or at least one of, the plurality of couplers BA may have an irregular shape and a three-dimensional structure. For example, each of, or at least one of, the plurality of couplers BA may have a shape that protrudes in a direction (e.g., a third direction D3) that is substantially perpendicular to the surface PW_U of the support layer PW and/or in a direction (e.g., a first direction D1 or a second direction D2) that is substantially parallel to the surface PW_U of the support layer PW. The plurality of couplers BA may be spaced apart from each other along the first direction D1 and/or along the second direction D2.

The metal layer ML may be disposed on the surface PW_U of the support layer PW. The metal layer ML may fill a space between the plurality of couplers BA, and may be substantially uniformly disposed on the surface PW_U of the support layer PW. An adhesive force between the metal layer ML and the support layer PW may range, for example, from about 700 N/m to about 1,200 N/m.

According to some example embodiments of the present disclosure, the metal layer ML may substantially uniformly fill a space between the plurality of couplers BA. The plurality of couplers BA may allow an increase in contact area between the surface PW_U of the support layer PW and the metal layer ML. Thus, there may be an improvement in adhesive force between the metal layer ML and the support layer PW.

A thickness ML_T of the metal layer ML may range, for example, from about 0.3 μm to about 1.5 μm. The metal layer ML may include a first region ML1 and a second region ML2. The first region ML1 may include at least one of copper and copper oxide. The first region ML1 may refer, for example, to a region which thickness is in a range between about 10 nm and about 200 nm from the surface PW_U of the support layer PW. A thickness ML1_T of the first region ML1 may range, for example, from about 10 nm to about 200 nm.

The second region ML2 may include copper. The second region ML2 may refer, for example, to a region from an upper portion ML1_U of the first region ML1 to a top surface ML_U of the metal layer ML. A thickness ML2_T of the second region ML2 may range, for example, from about 290 nm to about 1.3 μm. The metal layer ML may correspond to the current collector COL2 discussed above with reference to FIG. 1.

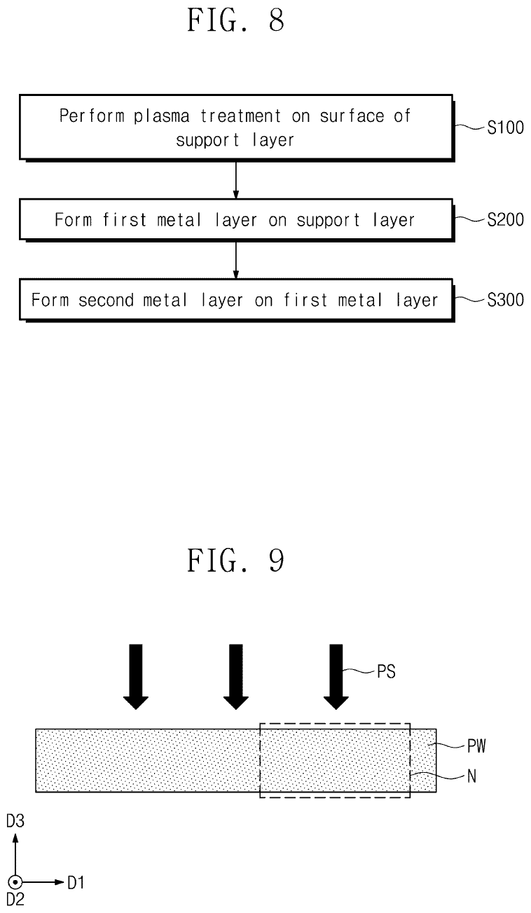

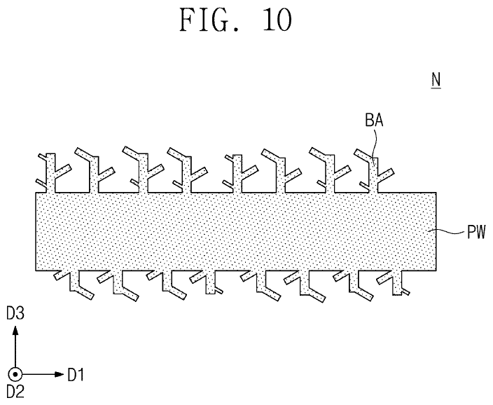

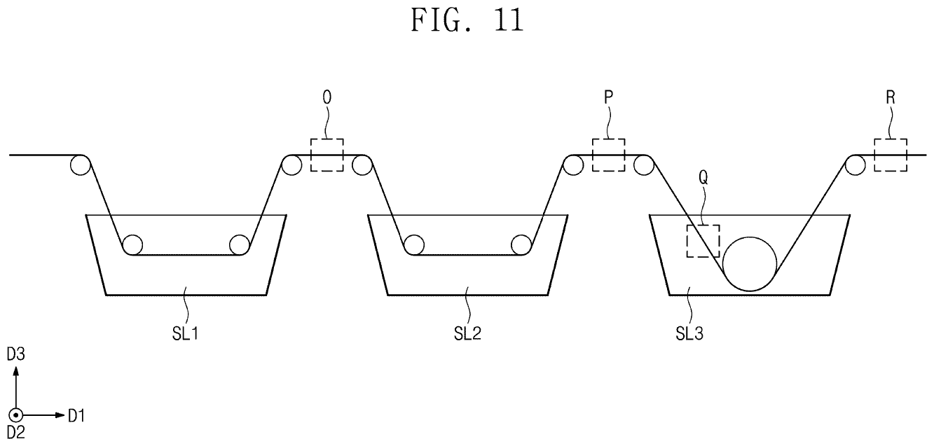

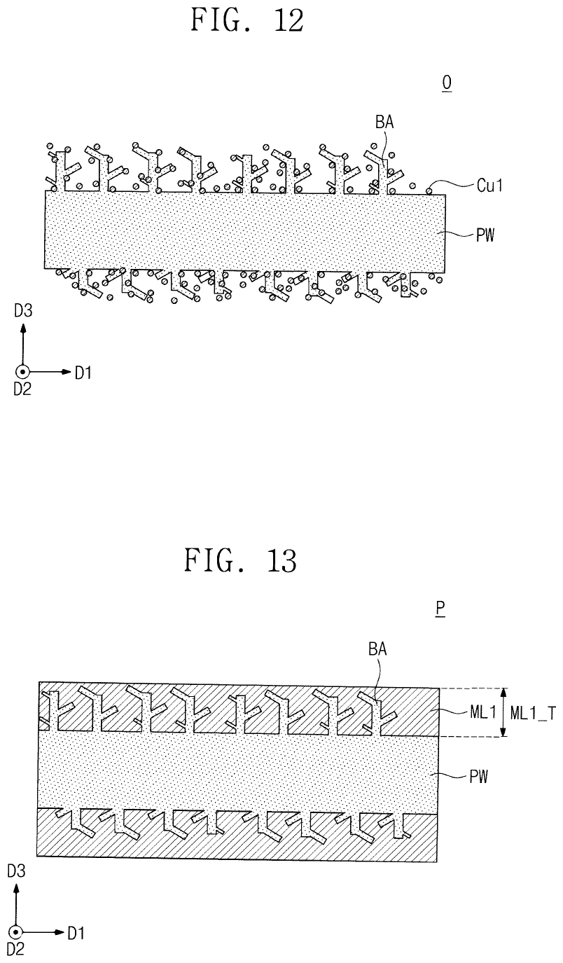

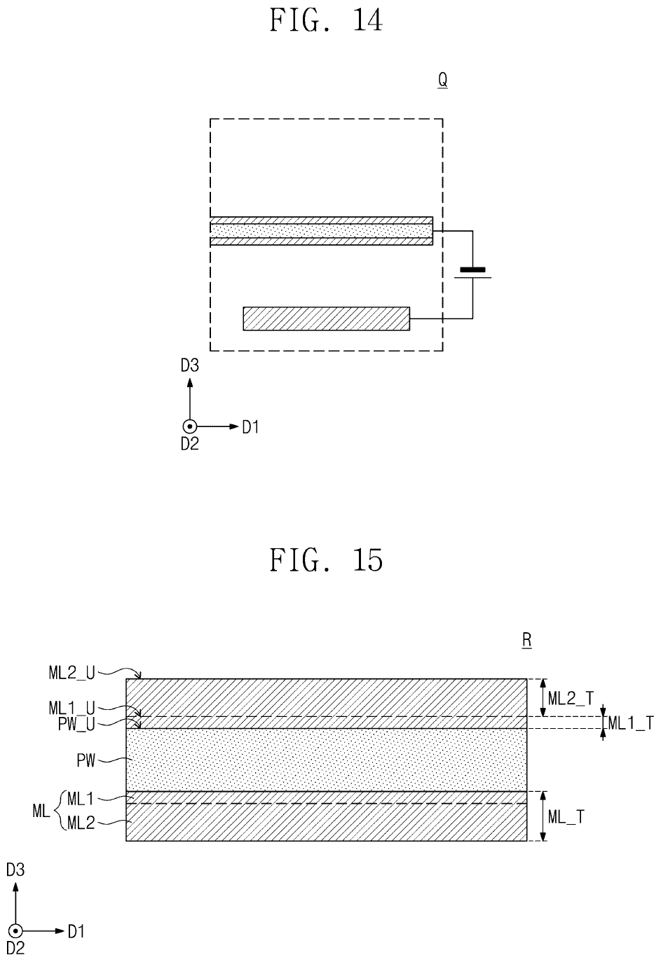

FIG. 8 is a flow chart illustrating a method of fabricating a negative electrode composite substrate for a rechargeable lithium battery, according to some example embodiments of the present disclosure. FIG. 9 is a cross-sectional view illustrating a plasma treatment of a surface of a support layer, according to some example embodiments of the present disclosure. FIG. 10 is an enlarged view illustrating section “N” of FIG. 9. FIG. 11 is a conceptual diagram illustrating a method of forming a first metal layer and a second metal layer, according to some example embodiments of the present disclosure. FIG. 12 is an enlarged view illustrating section “O” of FIG. 11. FIG. 13 is an enlarged view illustrating section “P” of FIG. 11. FIG. 14 is an enlarged view illustrating section “Q” of FIG. 11. FIG. 15 is an enlarged view illustrating section “R” of FIG. 11. A repetitive explanation of the rechargeable lithium battery discussed with reference to FIGS. 1 to 7 is omitted for brevity of description.

Referring to FIG. 8, a method of fabricating a negative electrode composite substrate for a rechargeable lithium battery, according to some example embodiments of the present disclosure, may include performing a plasma treatment on a surface of a support layer PW (S100), forming a first metal layer ML1 on the support layer PW (S200), and forming a second metal layer ML2 on the first metal layer ML1 (S300).

Referring to FIGS. 8 to 10, at least a portion of the surface of the support layer PW may be treated with plasma PS. The plasma PS may include, for example, oxygen as an active gas, and argon as an inert gas. The treatment using the plasma PS may cause the surface of the support layer PW to include a functional group including oxygen. For example, the surface of the support layer PW may include at least one of —O²⁻, —OH, and —COOH.

The treatment using the plasma PS may form a plurality of couplers BA on the surface of the support layer PW. The plurality of couplers BA may be formed by physical contact (or collision) between ions of the plasma PS and the surface of the support layer PW. Each of, or at least one of, the plurality of couplers BA may have an irregular shape and a three-dimensional structure. For example, each of, or at least one of, the plurality of couplers BA may have a shape that protrudes in a direction (e.g., a third direction D3) that is substantially perpendicular to the surface of the support layer PW and/or in a direction (e.g., a first direction D1 or a second direction D2) that is substantially parallel to the surface of the support layer PW. The plurality of couplers BA may be spaced apart from each other along the first direction D1 and/or the second direction D2.

Referring to FIGS. 8, 11, and 12, the support layer PW may be impregnated in a first solution SL1 including a first copper ion Cu1. The first solution SL1 may include a catalyst and a first metal salt that includes the first copper ion Cu1. The first metal salt may be or include, for example, one of CuSO₄ and CuCl₂. A concentration of the first metal salt in the first solution SL1 may range, for example, from about 0.12 M to about 0.25 M. The catalyst may be or include, for example, at least one of palladium (Pd) and platinum (Pt).

The first copper ion Cu1 may be adsorbed to the surface of the support layer PW. For example, the first copper ion Cu1 may be located between the plurality of couplers BA. The first copper ion Cu1 may interact with a functional group (e.g., —O²⁻, —OH, and —COOH), including oxygen, on the surface of the support layer PW, thereby becoming stable. For example, the first copper ion Cu1 may be stabilized through a coordinate bond with at least one of —O²⁻, —OH, and —COOH on the surface of the support layer PW. A plurality of first copper ions Cu1 may be substantially uniformly positioned between the plurality of couplers BA and on the surface of the support layer PW.

Referring to FIGS. 8, 11, and 13, a first metal layer ML1 may be formed on the support layer PW. The formation of the first metal layer ML1 may include impregnating the support layer PW with a second solution SL2 including a reductant. The reductant may reduce the first copper ion Cu1 adsorbed to the surface of the support layer PW, and the first metal layer ML1 may be formed on the surface of the support layer PW.

The first metal layer ML1 may include at least one of copper originated from the first copper ion Cu1, and copper oxide originated from a functional group including oxygen on the surface of the support layer PW. A thickness ML1_T of the first metal layer ML1 may range, for example, from about 10 nm to about 200 nm. The first metal layer ML1 may correspond to the first region ML1 of the metal layer ML discussed above with reference to FIGS. 6 and 7.

The reductant included in the second solution SL2 may include at least one of formaldehyde, glucose, sodium hypophosphite, and boron compounds such as sodium borohydride. The second solution SL2 may further include at least one of a complexing agent, a stabilizer, and a pH adjuster. The complexing agent may include, for example, ethylenediaminetetraacetic acid (EDTA). The stabilizer may include one or more of triethylamine (TEA) and 2,2′-bipridine. The pH adjuster may include, for example, NaOH. The second solution SL2 may have, for example, a pH in a range of about 11 to about 13. When the pH of the second solution SL2 falls within the range above, the first metal layer ML1 may be substantially uniformly deposited on the surface of the support layer PW.

According to some example embodiments of the present disclosure, an electroless plating process may be performed to form the first metal layer ML1 on the support layer PW. Therefore, the first metal layer ML1 may be substantially uniformly formed on the support layer PW having no conductivity, and an increased adhesive force may be provided between the first metal layer ML1 and the support layer PW.

Referring to FIGS. 8, 11, 14, and 15, a second metal layer ML2 may be formed on the first metal layer ML1. The formation of the second metal layer ML2 may include impregnating the support layer PW and the first metal layer ML1 on the support layer PW with a third solution SL3 including a second copper ion.

Referring to FIG. 14, the formation of the second metal layer ML2 may include performing an electrolytic plating process. The support layer PW and the first metal layer ML1 on the support layer PW may be connected to a negative electrode, and a copper electrode including the second copper ion may be included as a positive electrode. In this case, a constant voltage in a range of about 5 V to about 15 V may be applied.

Referring back to FIGS. 8, 11, and 15, the third solution SL3 may further include at least one of an electrolyte, a complexing agent, and a pH adjuster. The electrolyte may include, for example, at least one of copper sulfate (CuSO₄), sulfuric acid (H₂SO₄), hydrochloric acid (HCl), copper chloride (CuCl₂), and acetic acid (C₂H₄O₂). The complexing agent may include, for example, ethylenediaminetetraacetic acid (EDTA). The pH adjuster may include, for example, one or more of hydrochloric acid, acetic acid, sulfuric acid, and citric acid. The third solution SL3 may have, for example, a pH in a range of about 0.5 to about 2.5. When the pH of the third solution SL3 falls within the range above, the second metal layer ML2 may be substantially uniformly formed on the first metal layer ML1.

The first metal layer ML1 and the second metal layer ML2 may constitute a single unitary piece. The first metal layer ML1 and the second metal layer ML2 may be collectively referred to as the metal layer ML illustrated in FIGS. 6 and 7. The first metal layer ML1 and the second metal layer ML2 may include the same metal (e.g., copper), and thus the second metal layer ML2 may be stably formed on the first metal layer ML1. The second metal layer ML2 may correspond to the second region ML2 of the metal layer ML discussed above with reference to FIGS. 6 and 7.

In addition, the formation of the first metal layer ML1 and the formation of the second metal layer ML2 may be successively performed. It may thus be possible to reduce cost and time required for a fabrication process of a composite substrate for a rechargeable lithium battery.

The following describes the present disclosure through examples and comparative examples.

### Embodiment 1

A polypropylene film of 2 μm in thickness was prepared as a support layer. An oxygen plasma treatment and an argon plasma treatment were executed on a surface of the support layer. Thereafter, the support layer was impregnated in a first solution including 0.12 M of CuSO₄ and palladium (Pd).

Then, the support layer was impregnated in a second solution including formaldehyde, ethylenediaminetetraacetic acid (EDTA), triethylamine (TEA), and NaOH, thereby forming a first metal layer. 0.1 M of formaldehyde, 0.01 M of EDTA, 0.02 M of TEA, and 0.2 M of NaOH were mixed to prepare the second solution. A pH of the second solution was 11. A thickness of the first metal layer was 200 nm.

The first metal layer and the support layer were impregnated in a third solution. 0.12 M of CuSO₄, 0.01 M of EDTA, and 0.15 M of acetic acid were mixed to prepare the third solution. A constant voltage of 15 V was applied between a positive electrode formed of copper metal and a negative electrode to which the first metal layer and the support layer were connected. Therefore, a second metal layer was formed on the first metal layer. A sum of thickness of the first and second metal layers was 1.5 μm.

### Embodiment 2

A composite substrate was fabricated in the same method as that in Embodiment 1, with a difference that a polyethylene film was included as the support layer.

### Comparative 1

A polypropylene film of 2 μm in thickness was prepared as a support layer. A sputtering process was employed such that a first metal layer formed of nickel chromium alloy was deposited on the support layer. A thickness of the nickel chromium alloy was 13 μm. Then, a second metal layer was formed by the same method as that of Embodiment 1.

### Comparative 2

A polyethylene film of 2 μm in thickness was prepared as a support layer. A sputtering process was employed such that a first metal layer formed of nickel chromium alloy was deposited on the support layer. A thickness of the nickel chromium alloy was 13 μm. Then, a second metal layer was formed by the same method as the method of Embodiment 1.

### Evaluation

The support layer was fixed, and the first metal layer was pulled at an angle of 90°. An adhesive force was measured based on ASTM D6862 standard. The result of the adhesive force evaluation is shown in Table 1 below.

TABLE 1

| | Adhesive force (N/m) |
|---|---|
| Embodiment 1 | 750 |
| Embodiment 2 | 1130 |
| Comparative 1 | 650 |
| Comparative 2 | 1000 |

Referring to FIG. 1, it may be observed that Embodiment 1 exhibits an adhesive force that is higher than the adhesive force of Comparative 1. Likewise, it may be observed that Embodiment 2 exhibits an adhesive force that is higher than the adhesive force of Comparative 2. Accordingly, it may be ascertained that the composite substrates according to some example embodiments of the present disclosure have desired or improved stability.

In a method of fabricating a negative electrode composite substrate for a rechargeable lithium battery, according to some example embodiments of the present disclosure, an electroless plating process may be performed to form a first metal layer on a support layer. Thus, the first metal layer may be substantially uniformly formed on a surface of the support layer. In addition, a desired or improved adhesive force may be provided between the first metal layer and the support layer. Accordingly, it may be possible to provide a negative electrode composite substrate for a rechargeable lithium battery, the composite substrate exhibiting improved stability.

According to the fabrication method of the present disclosure, after the formation of the first metal layer, a second metal layer may be successively formed on the first metal layer. The successive process may be performed to form the first metal layer and the second metal layer, and thus there may be a reduction in time and cost required for the fabrication process. Thus, it may be possible to provide a cost-effective method of fabricating a negative electrode composite substrate for a rechargeable lithium battery.

Although some example embodiments of the present disclosure have been discussed with reference to accompanying figures, it is understood that various changes in form and details may be made therein without departing from the spirit and scope of the present disclosure. It is apparent to those skilled in the art that various substitution, modifications, and changes may be made thereto without departing from the scope and spirit of the present disclosure.

What is claimed is:

1. A method of fabricating a negative electrode composite substrate for a rechargeable lithium battery, the method comprising:
performing a plasma treatment on at least a portion of a surface of a support layer;
forming a first metal layer on the surface of the support layer; and
forming a second metal layer on the first metal layer,
wherein forming the first metal layer comprises:
impregnating the support layer with a first solution including a first copper ion to adsorb the first copper ion to the surface of the support layer; and
impregnating the support layer with a second solution including a reductant to reduce the first copper ion,
wherein forming the second metal layer comprises:
impregnating the support layer and the first metal layer on the support layer with a third solution including a second copper ion.

2. The method of claim 1, wherein the plasma treatment comprises an oxygen plasma treatment.

3. The method of claim 1, wherein the reductant of the second solution comprises at least one of formaldehyde, glucose, sodium hypophosphite, and boron compounds.

4. The method of claim 1, wherein a pH of the second solution is in a range of about 11 to about 13.

5. The method of claim 1, wherein the support layer comprises at least one of a polyethylene film, a polypropylene film, a polyvinylidene chloride film, and a multi-layered film including any combination thereof.

6. The method of claim 1, wherein the first metal layer comprises at least one of copper and copper oxide.

7. The method of claim 1, wherein a thickness of the support layer is in a range of about 2 μm to about 10 μm.

8. The method of claim 1, wherein the third solution further comprises an electrolyte, a complexing agent, and a pH adjuster.

9. The method of claim 8, wherein the electrolyte comprises at least one of copper sulfate (CuSO₄), sulfuric acid (H₂SO₄), hydrochloric acid (HCl), copper chloride (CuCl₂), and acetic acid (C₂H₄O₂).

10. The method of claim 1, wherein a pH of the third solution is in a range of about 0.5 to about 2.5.

11. The method of claim 1, wherein the surface of the support layer that is plasma treated comprises at least one of —O²⁻, —OH, and —COOH.

12. The method of claim 1, wherein forming the first metal layer and forming the second metal layer are successively performed.

13. The method of claim 1, wherein an adhesive force between the support layer and the first metal layer is in a range of about 700 N/m to about 1,200 N/m.

14. The method of claim 1, wherein the first metal layer and the second metal layer are configured into a single unitary piece.

15. A negative electrode composite substrate for a rechargeable lithium battery, the composite substrate comprising:
a support layer that comprises a polymer film;
a metal layer on the support layer and comprising at least one of copper and copper oxide; and
a negative electrode coating layer on the metal layer,
wherein a thickness of the support layer is in a range of about 2 μm to about 10 μm, and
wherein an adhesive force between the metal layer and the support layer is in a range of about 700 N/m to about 1,200 N/m.

16. The composite substrate of claim 15, wherein the metal layer comprises:
a first region on the support layer; and
a second region on the first region,
wherein the first region comprises at least one of copper and copper oxide, and
wherein the second region comprises copper.

17. The composite substrate of claim 16, wherein:
a thickness of the first region is in a range of about 10 nm to about 200 nm, and
a thickness of the second region is in a range of about 290 nm to about 1.3 μm.

18. The composite substrate of claim 15, wherein the negative electrode coating layer comprises a negative electrode active material, a binder, and a conductive material.

19. The composite substrate of claim 18, wherein the binder comprises one or more of polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and nylon.

20. The composite substrate of claim 15, wherein the polymer film comprises at least one of a polyethylene film, a polypropylene film, a polyvinylidene chloride film, and a multi-layered film including any combination thereof.
